(19) United States
(12) Patent Application Publication
(10) Pub. No.: US 2005/0278500 A1
(43) Pub. Date: Dec. 15, 2005

(54) Addressing type data comparison circuit

(75) Inventor: Di Tang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/142,265

(22) Filed: Jun. 2, 2005

(30) Foreign Application Priority Data
Jun. 15, 2004 (TW) 093117162

(51) Int. Cl. G06F 12/00

(52) U.S. Cl. 711/200

(57) ABSTRACT

The present invention relates to an addressing type data comparison circuit that uses an addressing system, which enables an external circuit to receive a standard value and a comparison value. Through the process of addressing type data comparison circuit, the addressing type data comparison circuit outputs the operation result to a external circuit. The addressing system of transferring can effectively make use of a memory and economize the design of a circuit, which can enhance the integration of a circuit.

### BACKGROUND OF THE INVENTION

1. Field of the Invention

The present invention relates to data comparison circuit and, more particularly, to an addressing type data comparison circuit.

2. Description of Related Art

Conventionally, a central processing unit (CPU) comprises the following components: a control unit, arithmetic and logic units (ALUs), and registers; the control unit coordinates and directs the transfers and operations of data between the various units of the CPU, which helps the CPU to carry out instructions; the ALUs comprise arithmetic and logic units, which can respectively execute arithmetic operations (such as addition, subtraction, multiplication, division) and logic operations (such as AND, OR, NOT), and the calculated results are outputted to the registers. The ALUs comprise dividers, and when the CPU received instructions, it sifts out division instructions and division parameters for the divider to perform operations; then, the results from the divider are outputted. Because the address of the divider is set by the CPU, the resource of the CPU is wasted and its efficiency is impaired.

Therefore, it is desirable to provide an improved speech recognition method to mitigate and/or obviate the aforementioned problems.

### SUMMARY OF THE INVENTION

The main purpose of the present invention is to provide an addressing type data comparison circuit, which takes advantages of addressing to control inputs and outputs of data. As a result, the space of the memory can be used effectively, and the cost for extra memories can be saved.

The other purpose of the present invention is to provide an addressing type data comparison circuit, which takes advantages of addressing to control inputs and outputs of the data in order to enhance the integration of the circuit.

The present invention provides an addressing type data comparison circuit for receiving a standard value and a comparison value of addressing input from an external circuit, using a hardware address to perform the addressing operation for outputting an operation result to the external circuit, comprising: a bus; a data acquisition controller connected to the bus in order to get the address and data that are inputted by the bus; a plurality of pins, used to control the input/output status of the data of the addressing type data comparison circuit; an addressing type input register, used to save the standard value and the comparison value inputted from the external circuit; a comparator for receiving the standard value and the comparison value from the addressing type input register, so as to perform a comparison, wherein the comparator including; a standard value register, used to save the standard value inputted by the addressing type input register; and a comparison value register, used to save the comparison value inputted by the addressing type input register; an addressing type output register, for receiving the operation result from the comparator and outputting to the external circuit.

The plurality of control pins comprise a ALE pin, a NWR pin, and a NRD pin, using to control data transmission of the bus.

Other objects, advantages, and novel features of the invention will become more apparent from the following detailed description when taken in conjunction with the accompanying drawings.

### BRIEF DESCRIPTION OF THE DRAWINGS

FIG. 1 is a functional diagram of this present invention.

### DETAILED DESCRIPTION OF THE PREFERRED EMBODIMENT

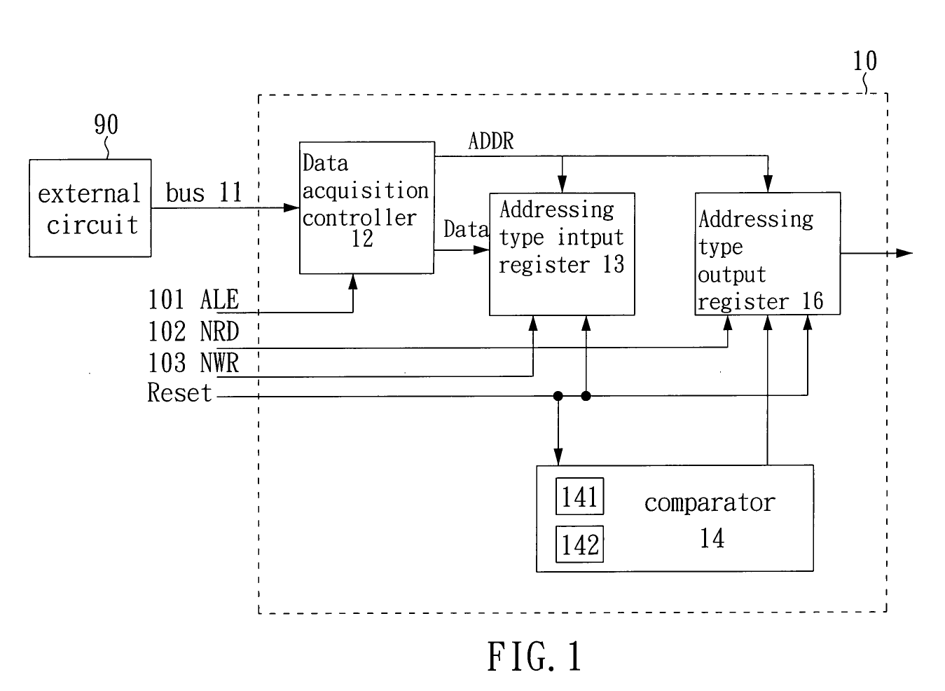

With reference to FIG. 1, an addressing type data comparison circuit is shown, which is comprised of a bus 11, a data acquisition controller 12, an ALE pin 101, a NRD pin 102, a NWR pin 103, an addressing type input register 13, an addressing type output register 16 and a comparator 14. In this embodiment, the bus 11 is a general bus, which is compatible with the address bus and the data bus. The data acquisition controller 12 is connected to the bus 11, in order to get the inputted data and address from the bus. The ALE pin 101, NRD pin 102, and NWR pin 103 are used to control the data transmission of the addressing type data comparison circuit 10. The addressing type input register 13 is used for saving the standard value and the comparison value inputted from the external circuit 90. The comparator 14 receives the standard value and the comparison value for performing a comparison, wherein the comparator 14 comprises a standard value register 141, used to save the standard value inputted by the addressing type input register 13; and a comparison value register 142, used to save the comparison value inputted by the addressing type input register 13. The addressing type output register 16 receives the operation result from the comparator 14 and outputs to the external circuit 90.

In this embodiment, the bus 11 uses package containing address and data to perform data transmission. The address of the package used to compare with the ALE pin 101, the NRD pin 102, and the NWR pin 103 for determining whether the address of the package is equivalent to the address of the pins, if true, beginning performing data transmission.

In this embodiment, the hardware address of the addressing type data comparison circuit 10 can be set by the user, and such self-set address is saved in the register (not shown). When the external circuit 90 outputs an address signal, if the hardware address of this address signal matches the hardware address of the addressing type data comparison circuit 10, the addressing type data comparison circuit 10 will enable to receive the data from the bus 11.

Through the bus 11, the addressing type data comparison circuit 10 receives the standard value and the comparison value from the external circuit 90, and outputs the operation result to the external circuit 90.

As shown in FIG. 1, firstly, the addressing type data comparison circuit 10 should be reset first before performing a comparison, in order to assure the accuracy of the data. When the external circuit 90 transfers data to the addressing type data comparison circuit 10 through the bus 11, the data acquisition controller 12 will separate the data from the bus 11 into two categories: address and data. In this embodiment, the data is standard value or comparison value, depending on the designated address and the cooperated NRW pin 103, the divisor and the dividend will be sent to the addressing type input registers 13 to be operated. When the comparator 14 is ready to perform an comparison, the addressing type data comparison circuit 10 will input the standard value to the standard value register 141 and input the comparison value to the comparison value register 142. After finishing the comparison, the comparator will transmit the operation result to the addressing type output register 16, depending on the designated address and the cooperated NRD pin 103, the addressing type output register 16 will transfer the quotient and remainder to the external circuit 90.

Although the present invention has been explained in relation to its preferred embodiment, it is to be understood that many other possible modifications and variations can be made without departing from the spirit and scope of the invention as hereinafter claimed.

1. An addressing type data comparison circuit for receiving a standard value and a comparison value of addressing input from an external circuit, using a hardware address to perform the addressing operation for outputting an operation result to the external circuit, comprising:
a bus;
a data acquisition controller connected to the bus in order to get the address and data that are inputted by the bus;
a plurality of pins, used to control the input/output status of the data of the addressing type data comparison circuit;
an addressing type input register, used to save the standard value and the comparison value inputted from the external circuit;
a comparator for receiving the standard value and the comparison value from the addressing type input register, so as to perform a comparison, wherein the comparator including;
a standard value register, used to save the standard value inputted by the addressing type input register; and
a comparison value register, used to save the comparison value inputted by the addressing type input register; and
an addressing type output register, for receiving the operation result from the comparator and outputting to the external circuit.

2. The circuit as claimed in claim 1, wherein the plurality of control pins comprise an ALE pin.

3. The circuit as claimed in claim 1, wherein the plurality of control pins comprise a NWR pin.

4. The circuit as claimed in claim 1, wherein the plurality of control pins comprise a NRD pin.

5. The circuit as claimed in claim 1, wherein as the addressing type data comparison circuit uses the ALE pin to control data transmission of the bus, the data of the bus is an address.

6. The circuit as claimed in claim 1, wherein as the addressing type data comparison circuit uses the NWR pin to control data transmission of the bus, the data of the bus is inputted to the addressing type data comparison circuit.

7. The circuit as claimed in claim 1, wherein as the addressing type data comparison circuit uses the NRD pin to control data transmission of the bus, the data of the bus is outputted from the addressing type of data comparison circuit.
